(19) United States
(12) Patent Application Publication
(10) Pub. No.: US 2018/0347539 A1
(43) Pub. Date: Dec. 6, 2018

(54) DEVICE FOR CONVERTING WIND ENERGY TO AT LEAST MECHANICAL ENERGY

(71) Applicant: Home Turbine B.V., Rijssen (NL)

(72) Inventor: William Erik VAN DER SCHEE, RIJSSEN (NL)

(21) Appl. No.: 15/761,588

(22) PCT Filed: Sep. 21, 2016
(86) PCT No.: PCT/NL2016/050649

§ 371 Date: Mar. 20, 2018

(30) Foreign Application Priority Data
Sep. 21, 2015 (NL) 1041477

(51) Int. Cl. F03D 1/04

(52) U.S. Cl. CPC F03D 1/04; F05B 2250/25; F05B 2240/123; F05B 2240/133; F05B 2220/706; F05B 2250/182; F05B 2250/183; F05B 2250/16; F05B 2250/184

(57) ABSTRACT

The invention relates to a device for converting wind energy to at least mechanical energy, comprising a rotor with a number of rotor blades drivable rotatably about a rotation axis by wind and a duct disposed therearound, wherein a central axis of the duct substantially coincides with the rotation axis of the rotor, characterized by guide means disposed upstream of the rotor for guiding the wind in a substantially helical movement round the central axis during use of the device such that the wind is supplied in the substantially helical movement round the central axis to the rotor.

### BACKGROUND OF THE INVENTION

### 1. Field of the Invention

The invention relates to a device for converting wind energy to at least mechanical energy.

### 2. Description of the Related Art

Devices for converting wind energy to at least mechanical energy, comprising a rotor with a number of rotor blades drivable rotatably about a rotation axis by wind and a duct disposed therearound, wherein a central axis of the duct substantially coincides with the rotation axis of the rotor, are known per se.

Such a device for converting wind energy to at least mechanical energy is also referred to as a wind turbine or windmill.

It is an object of the invention to improve the per se known device. A particular object of the invention can be to increase the efficiency of the per se known device.

### SUMMARY OF THE INVENTION

This object is achieved with a device for converting wind energy to at least mechanical energy, comprising a rotor with a number of rotor blades drivable rotatably about a rotation axis by wind, a duct disposed therearound, wherein a central axis of the duct substantially coincides with the rotation axis of the rotor, and guide means disposed upstream of the rotor for guiding the wind in a substantially helical movement round the central axis during use of the device such that the wind is supplied in the substantially helical movement round the central axis to the rotor.

By supplying the wind airflow in said helical movement round the central axis to the rotor the airflow is supplied substantially to an outer peripheral zone of the rotor, whereby the pressure increases at the outer peripheral zone of the rotor and decreases in the area of the rotation axis. This provides for an increased torque on the rotor blades of the rotor, whereby the efficiency of the rotor can increase.

Another effect of said helical movement of the airflow round the central axis is that the resistance of the airflow in the duct can hereby decrease relative to a non-helical airflow flowing through a duct.

It is noted that the guide means are disposed particularly in the duct, more particularly just in front of the rotor as seen in flow direction.

It is further noted that the duct can comprise any suitable cross-sectional form. The duct here preferably has a circular cross-sectional form at least in the area of the rotor so that the part of the duct where the rotor is disposed is substantially cylindrical. A wind inlet opening and/or a wind outlet opening of the duct can also have a substantially circular cross-section. In that case the duct preferably has a circular cross-sectional form at any random location along its length. The wind inlet opening and/or the wind outlet opening can alternatively have any other suitable cross-sectional form, such as for instance oval. In the case of such a non-circular cross-sectional form of the wind inlet opening and/or the wind outlet opening the duct preferably transposes gradually to the circular cross-sectional form in the area of the rotor.

Said substantially helical movement can extend here in substantially circular manner round the central axis, optionally with increasing cross-sectional dimension or diameter as will be further elucidated below, but also in a non-circular manner, such as for instance ovally. The form of the helical movement round the central axis can be substantially adapted here to the cross-sectional form of the duct.

The invention can relate particularly to a relatively small wind turbine, also referred to as a microturbine or urban wind turbine, which wind turbine can be set up in an urban environment, and in particular optionally on a building. The invention can relate more particularly to a so-called horizontal wind turbine, wherein in use of the wind turbine the rotation axis of the rotor and the central axis of the duct are disposed substantially horizontally.

In an embodiment of the device according to the invention the guide means comprise a number of stator blades disposed in the duct, which stator blades extend radially outward from the central axis.

The intended effect of guiding the wind in said substantially helical movement round the central axis can take place effectively by selecting a suitable geometry and/or disposition of the stator blades.

In another embodiment of the device according to the invention the stator blades have a main plane extending radially from the central axis, which main plane is disposed at an oblique angle relative to the central axis.

The stator blades disposed obliquely relative to the central axis guide the airflow in the oblique direction defined by the stator blades relative to the central axis, whereby the airflow is guided in said helical movement round the central axis. The oblique angle of the stator blades here substantially determines the angle of the helical airflow to the central axis.

The oblique angle of the stator blades, and thereby the helical airflow relative to the central axis, is preferably selected subject to the velocity of the airflow in the duct and/or the rotation speed of the rotor. Since this velocity and/or the rotation speed can vary, it is advantageous for the stator blades to be adjustable for the purpose of adjusting the oblique angle.

In practical manner the stator blades are automatically adjustable subject to the velocity of the airflow in the duct and/or the rotation speed of the rotor. The device can for this purpose be provided with measuring means for measuring the velocity of the airflow in the duct and/or the rotation speed of the rotor, wherein the device is configured to adjust the oblique angle of the stator blades relative to the central axis subject to the measured velocity and/or rotation speed.

In yet another embodiment of the device according to the invention each stator blade is connected to the duct via a connecting shaft extending radially relative to the central axis such that the stator blade is pivotable about or with the connecting shaft for the purpose of adjusting the oblique angle of the stator blade relative to the central axis.

The device can alternatively comprise a central shaft coinciding with the central axis, wherein each stator blade is connected to the central shaft via a connecting shaft extending radially relative to the central shaft such that the stator blade is pivotable about or with the connecting shaft for the purpose of adjusting the oblique angle of the stator blade relative to the central axis.

The connecting shaft can optionally be connected to both the duct and the central shaft.

In practical manner each stator blade is connected fixedly to a respective connecting shaft so that the respective stator blade is adjusted to a chosen angle with the central shaft (axis) by pivoting the connecting shaft.

The oblique angle can for instance lie between or be adjustable between 10-80°, preferably between 20-60°.

In yet another embodiment of the device according to the invention each stator blade has at least one through-opening arranged therein.

The at least one opening limits the formation of air vortices behind the stator blade. Alternatively or additionally the at least one opening reduces the frontal surface area of the stator blade.

The stator blade can for instance be provided with a relatively small number, for instance one, of relatively large openings. The stator blade can alternatively be provided with a relatively large number of relatively small openings, for instance three or four, up to for instance a maximum of ten. The number of openings can hereby be for instance between one and ten. It is noted that the number of openings is not limited hereto. Each stator blade can comprise any suitable number of openings.

In practical manner the surface area of the at least one opening, or the combined surface area of a plurality of openings, is a minimum of 5% and a maximum of 60% of the surface area of a or the main plane of the stator blade.

The at least one opening can have any suitable and/or desired shape such as, though not only, circular. The minimal cross-sectional dimension, for instance the diameter in the case of a circular opening, is preferably greater than a quarter of the thickness of the stator blade.

The at least one opening can consist of any suitable and/or desired embodiment, such as, though not only, a hole or a cutaway.

In yet another embodiment of the device according to the invention each stator blade is provided with a number of upright ribs extending from a pressure side thereof, which ribs extend from a wind entry side of the blade to a wind exit side of the stator blade, wherein as seen in radial direction the ribs extend obliquely over said side such that on the wind exit side each rib is located at a greater radial distance from the central axis than on the wind entry side.

The ribs support the change in the flow direction of the airflow to said helical movement. The airflow is moreover guided outward in radial direction so that the airflow is supplied to the outer peripheral zone of the rotor, which rotor has an increased efficiency because of the thereby increased torque.

The ribs can particularly extend radially outward with a determined curvature over said side such that on the wind exit side each rib is located at said greater radial distance from the central axis than on the wind entry side.

The ribs can have a height lying between 0.1% and 25% of the maximum height of the stator blade.

The height of the stator blade is defined here in the radial direction, particularly from a position close to the central axis to a position close to the duct.

In yet another embodiment of the device according to the invention each stator blade comprises a wind entry side and a wind exit side, wherein the stator blade is provided on its wind exit side with an end edge, the second derivative of which changes sign more than once.

Such an end edge of the device according to this embodiment of the invention provides the advantage that the formation of air vortices behind the outflow edge is limited, whereby the airflow over the blades can be improved.

Applicant has found that a substantially sine-shaped end edge is particularly effective in limiting the formation of air vortices behind the outflow edge.

It is however also possible for the end edge to be substantially block tooth-shaped or sawtooth-shaped, these shapes likewise being able to at least partially provide the intended effect.

As further alternative the end edge can be provided with a number of elements which extend in a main plane of the stator blade and which each take the form of a parabola or a part of a circle. These shapes can also at least partially provide the intended effect.

In yet another alternative the end edge can be provided with a number of elements which extend in a main plane of the stator blade and which each take a substantially feather-like form. This shape can also at least partially provide the intended effect.

The end edge can optionally have a thickness varying along its length.

In another embodiment of the device according to the invention each rotor blade comprises a wind entry side and a wind exit side and is provided on its wind entry side with a front end edge, which front end edge comprises an inner end, which is disposed close to the rotation axis, and an outer end and wherein a main line of the front end edge between the inner end and the outer end takes a substantially curved form.

The form of the front end edge of the road blades is adapted here to the stator blades in order to obtain the greatest possible torque on the rotor provided by the airflow.

An angle of the main line close to the inner end of the front end edge relative to a straight line between the inner end and the outer end can here be greater than −45° and smaller than 45°, preferably greater than −35° and smaller than 35°.

An angle of the main line close to the outer end of the front end edge relative to a or the straight line between the inner end and the outer end can here be greater than −60° and smaller than 60°.

The rotor blades can be disposed at an angle to the rotation axis, wherein the angle is greater than 35° and smaller than 75°, preferably greater than 40° and smaller than 65°.

The number of rotor blades which the rotor comprises is preferably equal to the number of stator blades, this number being for instance between two and eight.

In yet another embodiment of the device according to the invention at least the inner side of the duct from the inlet opening to at least a position close to the rotor has the form of a Venturi narrowing in flow direction.

An advantage of the Venturi form is that the velocity of the airflow in the direction of the rotor is accelerated, whereby even at relatively low wind force the device is able to generate energy through driving of the rotor.

The Venturi form can be particularly advantageous in combination with said guide means, because the airflow can hereby also be guided upstream of the duct in said helical movement round the central axis. Because the helical movement has a radially outward component, the helical movement of the airflow upstream of the duct will have a greater cross-sectional dimension, for instance a larger diameter in the case of a wind inlet opening with a circular cross-sectional form, than the duct itself. The frontal surface area of wind from which the device can extract energy is hereby effectively enlarged relative to the physical size of the device, particularly relative to the inflow surface area of the duct.

In yet another embodiment of the device according to the invention the duct is provided on its outer side with at least one wind capture element extending radially outward, which at least one wind capture element is provided with at least one channel extending to the inner side of the duct.

An advantage of the wind capture elements is that wind flowing on the outer side of the duct is captured and fed to the inner side of the duct so that the amount of wind supplied to the rotor can increase and/or the possible Venturi effect can be enhanced.

The wind capture elements, particularly in combination with the above elucidated stator blades, provide the advantage that the efficiency of the wind turbine does not decrease, or at least does so to lesser extent, in turbulent wind flows, as can be the case with the per se known wind turbines. This is particularly advantageous in a built-up area where many turbulent flows can occur. According to such an embodiment comprising the wind capture elements and the stator blades, the wind turbine can hereby stand on a relatively low foot.

The at least one channel can preferably extend along at least a part of its length in flow direction through the duct in substantially helical form round the central axis for the purpose of supplying the wind in said substantially helical movement to the inner side of the duct.

The wind capture elements with channels can in this embodiment be the guide means for guiding the wind in said substantially helical movement round the central axis.

Wind capture elements with channels can in this embodiment alternatively be provided in addition to other guide means for guiding the wind in said substantially helical movement, so that the effect of the helical movement is reinforced.

In practical manner said part of the channel debouches with an outlet opening on the inner surface of the duct.

The channel, in particular the part thereof debouching on the inner surface, extends for instance at an angle greater than 0° and smaller than 120° to the central axis.

A dimension of the cross-sectional surface area of the at least one channel can decrease along at least a part of its length in downstream direction.

The flow speed of the air flow in the channel is hereby accelerated.

Three to six wind capture elements can for instance be provided which each extend over a part of the outer periphery of the duct and are optionally arranged distributed equally over the outer periphery.

The height of the or each wind capture element can for instance be 0.05×-0.2× the maximum cross-sectional dimension of the duct.

The width of the or each wind capture element can for instance be 1×-10× the height of the or each wind capture element.

In yet another embodiment of the device according to the invention the stator blades are provided with a structure, which structure has a pattern of recesses for receiving substantially stationary air.

An advantage of the pattern of recesses according to the invention, which serve to receive substantially stationary air, is that the surface of the stator blades in contact with the airflow flowing in the duct consists partially of the stationary air present in the recesses. For the part where the airflow is in contact with the stationary air present in the recesses air-to-air friction will occur, which provides for a lower friction than the parts where the airflow is in contact with the stator blades. The efficiency of the device can increase as a result of the reduction in the air friction of the airflow.

According to the invention the structure is characterized by one of the following features or a random combination thereof:
a depth of each recess is between 0.1×-2× the length of each recess;
a width of each recess is between 0.8×-3.5× the length of each recess;
the recesses have an oval shape, a longitudinal axis of which is disposed at an angle relative to the central axis, wherein the angle lies for instance between 0° and 45°;
the peripheral wall of each recess extends at an angle to the inner surface of the duct, wherein the angle lies for instance between 90 and 100°;
the peripheral wall of each recess is connected at a rounded angle to the bottom of each recess, wherein the rounded angle has for instance a radius of between 0×-1× the length of each recess;
the recesses are disposed adjacently of each other in a number of substantially straight lines, wherein the straight line extends at an angle relative to the central axis, wherein the angle lies for instance between 0° and 90°, wherein a centre-to-centre distance between two recesses disposed adjacently of each other in one line lies for instance between 1×-4× the width of each recess, and wherein the recesses of two mutually adjacently disposed lines of recesses are for instance arranged offset relative to each other, wherein the offsetting is for instance greater than 0× the length of each recess and a maximum of 2× the length of each recess.

The invention will be further elucidated with reference to the .drawings

### BRIEF DESCRIPTION OF THE DRAWINGS

FIGS. 1A-1D show schematically the wind turbine according to a first embodiment of the invention, wherein FIG. 1A is a perspective view from a wind inlet side, FIG. 1B is a side view, FIG. 1C is a perspective view from a wind outlet side, and FIG. 1D is a longitudinal vertical cross-section;

FIG. 2 shows schematically a perspective view of rotor and guide blades disposed in a duct of the wind turbine of FIG. 1;

FIGS. 3A and 3B show schematically in detail the valves on the wind outlet opening, wherein FIG. 3A shows the valves in an open state and FIG. 3B shows the valves in a closing state;

FIGS. 4A-4C show schematically a nanostructure which can be arranged on a number of surfaces of the wind turbine, wherein FIG. 4A is a top view of the nanostructure, FIG. 4B shows a detail of FIG. 4A and FIG. 4C shows a cross-section through the nanostructure.

FIGS. 5A-5C show schematically a rotor of the wind turbine of FIG. 1, wherein FIG. 5A is a perspective front view, FIG. 5B is a front view, FIG. 5C is a section in the longitudinal direction of the rotor of FIG. 5B; FIG. 5D shows a pressure side of a rotor blade and FIG. 5E is a rear view of the rotor blade; and

FIGS. 6A and 6B show schematically the wind turbine according to a second embodiment of the invention, wherein FIG. 6A is a perspective view from a wind inlet side and FIG. 6B is a front view.

### DETAILED DESCRIPTION

The various aspects of the invention will be elucidated with reference to the figures. The same elements will be designated here with the same reference numerals. The different aspects of the invention can be applied individually or in any random combination.

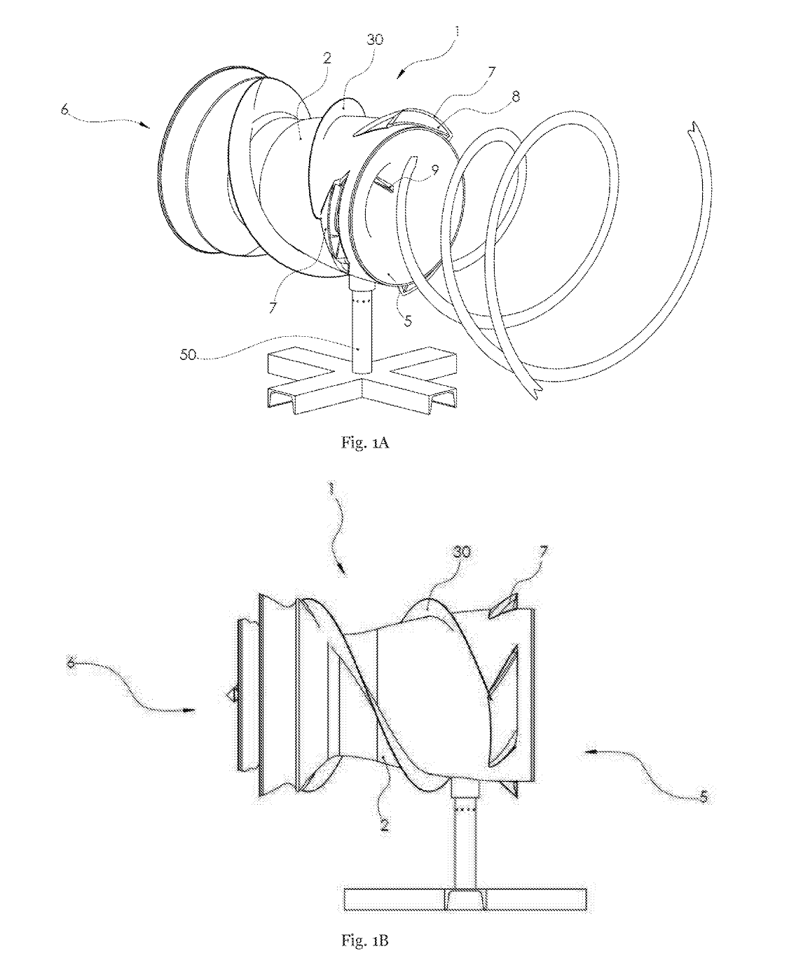

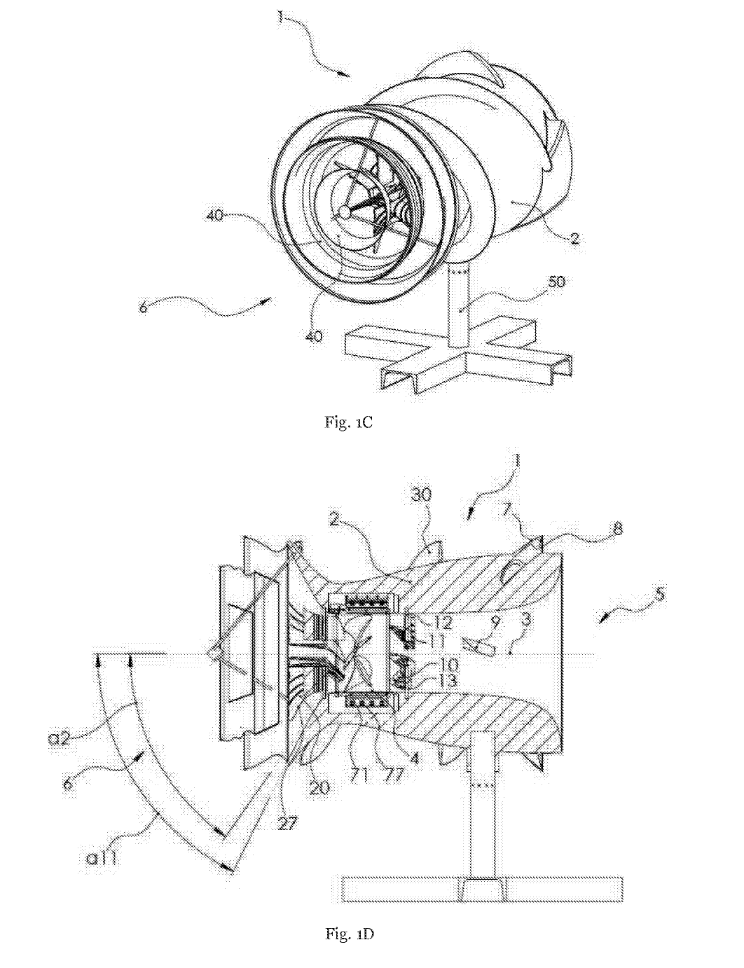

FIGS. 1A-1D show a wind turbine 1 according to a first embodiment of the invention. Wind turbine 1 comprises a duct 2 with a central axis 3. A rotor 4 is disposed in duct 2, wherein the central axis 3 of duct 2 substantially coincides with a rotation axis of rotor 4. Duct 2 has a wind inlet opening 5 and a wind outlet opening 6. In this first embodiment wind inlet opening 5 and wind outlet opening 6 are circular.

According to an aspect of the invention, duct 2 is provided on its outer side close to wind inlet opening 5 with a number of wind capture elements 7, in this example three, extending radially outward. Each wind capture element 7 is provided with a channel 8 extending to the inner side of duct 2. The three wind capture elements 7 are arranged distributed at an equal mutual angular distance over the outer surface of duct 2. Each channel 8 extends over substantially its full length in helical form in flow direction round the central axis through duct 2, and debouches with an outlet opening 9 on the inner surface of duct 2. Wind capture elements 7 capture wind flowing on the outer side of duct 2 and feed this wind in helical form to the inner surface of duct 2 via outlet openings 9.

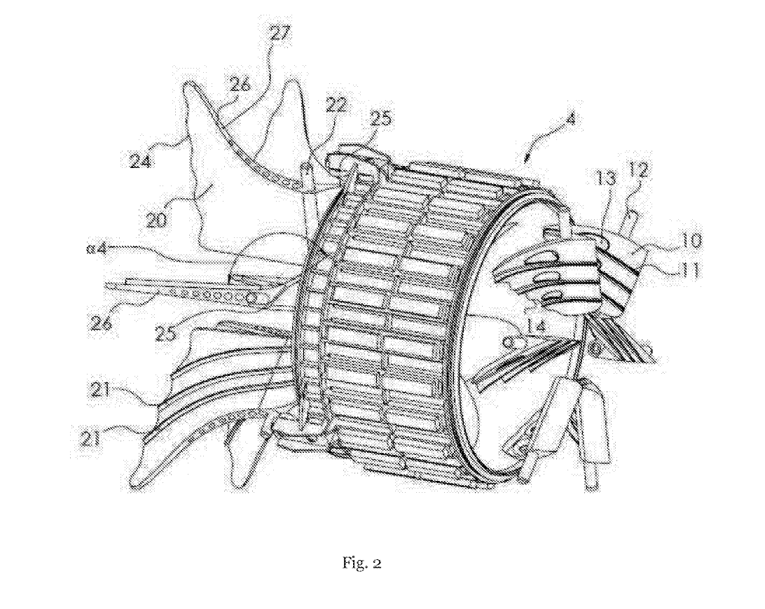

According to another aspect of the invention, see also FIG. 2, wind turbine 2 comprises a number of stator blades 10, in this example six, which are disposed upstream of rotor 4 in duct 2 and which extend radially outward from the central axis 3. Stator blades 10 have a main plane which extends radially from central axis 3 and which is disposed at an oblique angle relative to central axis 3. Because of the oblique angle of the main plane of stator blades 10 the wind flow flowing in duct 2 is guided in an oblique direction relative to central axis 3 so that the wind flow is guided in a substantially helical movement round the central axis 3. Each stator blade 10, in particular the main plane thereof, is provided with a number of upright ribs 11, in this example three. The upright ribs 11 extend from the pressure side of each stator blade 10 from an upstream wind entry side of blade 10 to a downstream wind exit side of stator blade 10. Ribs 11 extend obliquely outward as seen in radial direction over the wind guiding surface so that on the wind exit side each rib 11 is located at a greater radial distance from the central axis than on the wind entry side. The ribs support the change in the flow direction of the airflow to said helical movement round central axis 3. The desired angle of the helical movement of the wind round central axis 3 is preferably adjustable. Stator blades 10 are connected for this purpose to a connecting shaft 12 extending radially from central axis 3, which connecting shafts 12 are each connected at their radial outer end to duct 2. Stator blade 10 is pivotable about or with connecting shaft 12 for the purpose of adjusting the oblique angle of stator blade 10 relative to central axis 3. Each stator blade 10 is provided with a number of openings 13, in this example three. On the wind exit side each stator blade 10 is provided with a substantially sine-shaped end edge 14, the second derivative of which changes sign more than once.

According to another aspect of the invention, see FIG. 1D, the inner side of duct 2 takes the form, from wind inlet opening 5 up to for instance the location where connecting shaft 12 is disposed, of a Venturi narrowing in flow direction. In a part of duct 2 where rotor 4 is disposed the inner side of duct 2 is substantially cylindrical. Particularly the combination of the Venturi form of the inner side of duct 2 and the stator blades 10 ensures that the wind flows in helical form with a radially outward component upstream of the stator blades 10, so that the diameter of the wind flow supplied to wind turbine 2 upstream of wind inlet opening 5 increases in upstream direction, see also FIG. 1A.

According to another aspect of the invention, see FIG. 1D and FIG. 2, wind turbine 2 comprises a number of rear stator blades 20, in this example six, disposed in duct 2 downstream of rotor 4 and substantially connecting thereto for guiding the wind away from rotor 4 in a substantially downstream direction. Rear stator blades 20 extend radially outward from central axis 3. Each rear stator blade 20 is provided with a number of upright ribs 21, in this example three. Upright ribs 21 extend from the pressure side of each rear stator blade 20 from an upstream wind entry side of blade 20 to a downstream wind exit side of rear stator blade 20. Ribs 21 extend obliquely outward as seen in radial direction with a determined curvature over the wind guiding surface so that on the wind exit side each rib 21 is located at a greater radial distance from central axis 3 than on the wind entry side. Ribs 21 substantially convert a possible helical airflow coming from rotor 4 to a radially outward expanding airflow flowing substantially parallel to central axis 3. The angle of rear stator blades 20 to the central axis is preferably adjustable. Rear stator blades 20 are connected for this purpose to a connecting shaft 22 extending radially from central axis 3, which connecting shafts 22 are each connected at their radial outer end to duct 2. Rear stator blade 20 is pivotable about or with connecting shaft 22 for the purpose of adjusting the angle of rear stator blade 20 relative to central axis 3. On the wind exit side each rear stator blade 20 is provided with a substantially sine-shaped end edge 24, the second derivative of which changes sign more than once. Each rear stator blade 20 has substantially two blade parts 25, 26 disposed at an angle α4 relative to each other, wherein blade part 25 substantially connects to rotor 4 and blade part 26 is disposed downstream of blade part 25. Depending on the adjusted angle of rear stator blade 20, blade part 25 can extend substantially at an angle to central axis 3 and blade part 26 can extend substantially parallel to central axis 3. The angle α1 between blade parts 25, 26 is in this example around 130°. Blade part 26 has an increasing height so that the wind is guided substantially radially outward, and thereby expands. The increasing height of blade part 26 is optionally adapted to the form of the inner side of that part of duct 2 where blade part 26 is disposed, as will be further elucidated below.

According to another aspect of the invention, see FIG. 1D, a part of duct 2 extending from rotor 4 to wind outlet opening 6 widens in flow direction, particularly in the form of a Venturi. Duct 2 widens in Venturi form particularly on both its inner side and its outer side. Due to the Venturi form of the outer side of duct 2 the airflow flowing on the outer side of duct 2 is guided radially outward to some extent, whereby an underpressure is created in the area of outlet opening 6. An outlet angle α11 of wind outlet opening 6 to central axis 3 is in this example about 60°.

As elucidated above with reference to rear stator blades 20 and as shown in FIG. 1D and FIG. 2, the height of blade part 26 can be adapted here to the inner side of duct 2 widening in the form of a Venturi. A tangent of an upper edge 27 of each rear stator blade 20, and in particular of blade part 26 thereof, can make an angle α2 with central axis 3 which is adapted to the inner side of duct 2 widening in the form of a Venturi, and thereby increases in this example along its length in downstream direction from about 20° to about 80°.

According to another aspect of the invention, duct 2 has a thickness and/or form such that the flow distance of the wind through duct 2 is smaller than the flow distance round the outer side of duct 2, and that because of the form the flow direction round the outer side of duct 2 changes direction at the position of wind outlet opening 6. An underpressure is hereby created in the area of outlet opening 6.

According to another aspect of the invention, the diameter of wind outlet opening 6 of the duct is greater than an outer diameter of wind inlet opening 5 of duct 2.

According to another aspect of the invention, the outer periphery of duct 2 is provided with a helical upright rib 30. This lengthens the flow distance of the wind on the outer side of duct 2 compared to the flow distance of the wind through the inner side of duct 2, and it changes the flow direction round the outer side of duct 2. An underpressure is hereby created in the area of outlet opening 6.

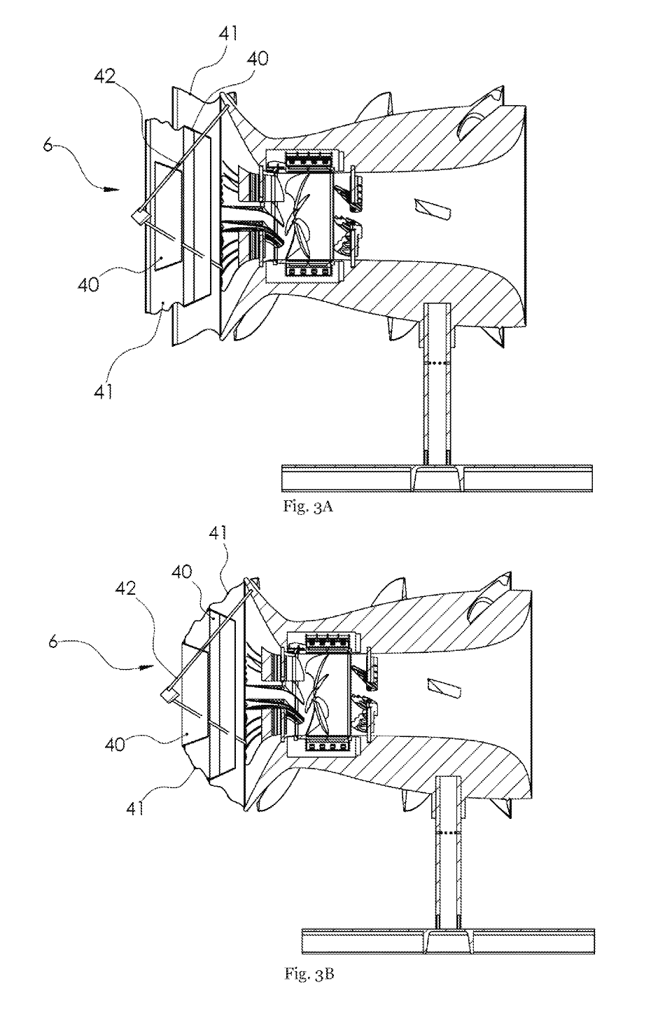

According to another aspect of the invention, see also FIGS. 3A, 3B, wind turbine 1 is provided in the area of wind outlet opening 6 of duct 2 with a number of annular elements 40, in this case two, disposed concentrically with outlet opening 6. Annular elements 40 each have a different diameter which are both smaller than the diameter of outlet opening 6. Annular elements 40 each comprise a cylindrical peripheral surface which extends obliquely outward in downstream direction at an angle to central axis 3. Annular elements 40 are therefore substantially conically widening annular elements. Due to the outward tapering form of annular elements 40 the wind flowing out of outlet opening 6 is guided radially outward. Arranged on duct 2 extending over the periphery of outlet opening 6 is a flexible valve 41 which is connected with one end zone to duct 2. Arranged on the outer annular element 40 is a flexible valve 41 which extends over the periphery thereof and which is connected with one end zone to annular element 40. In FIG. 3A valves 41 are shown in their open state, in which they leave outlet opening 6 substantially clear. The wind flowing out of wind outlet opening 6 moves the valves automatically into this open state. When the wind turns and threatens to flow into duct 2 via outlet opening 6, the wind pushes valves 41 automatically to their closing state as shown in FIG. 3B. In the closing state the valve 41 connected to duct 2 lies with its free end zone against the outer annular element 40, and the valve connected to the outer annular element 40 lies against the inner annular element 40 so that valves 41 substantially close at least the peripheral zone of wind outlet opening 6. Particularly the valve 41 connected to outlet opening 6 substantially closes the space between outlet opening 6 and the outer annular element 40. Particularly the valve 41 connected to outer annular element 40 substantially closes the space between outer annular element 40 and inner annular element 40. Bounding elements in the form of rods 42 extend between the peripheral end zone of outlet opening 6 of duct 2 and outer annular element 40 and between outer annular element 40 and inner annular element 40. These rods 42 prevent the flexible valves 41 blowing the valves 41 further inward from their closing state by the wind threatening to flow into outlet opening 6. In this example the inner annular element 40 is not provided with a valve, so that a central part of outlet opening 6 cannot be closed. This inner annular element 40 can if desired also be provided with a valve so that the central part of outlet opening 6 can be closed and outlet opening 6 can be substantially completely closed.

Wind turbine 1 according to the invention can particularly be a relatively small wind turbine, also referred to as a microturbine or urban wind turbine, which wind turbine can be set up in an urban environment, and in particular optionally on a building. Wind turbine 2 can for this purpose comprise a leg 50, using which the wind turbine can be set up. As shown in the figures, wind turbine 1 is particularly a so-called horizontal wind turbine, wherein the rotation axis of the rotor and the central axis 3 of duct 2 are disposed substantially horizontally during use of wind turbine 1.

An inner surface of the duct and/or rotor blades of the rotor is/are provided with a structure, which structure has a pattern of recesses for receiving substantially stationary air.

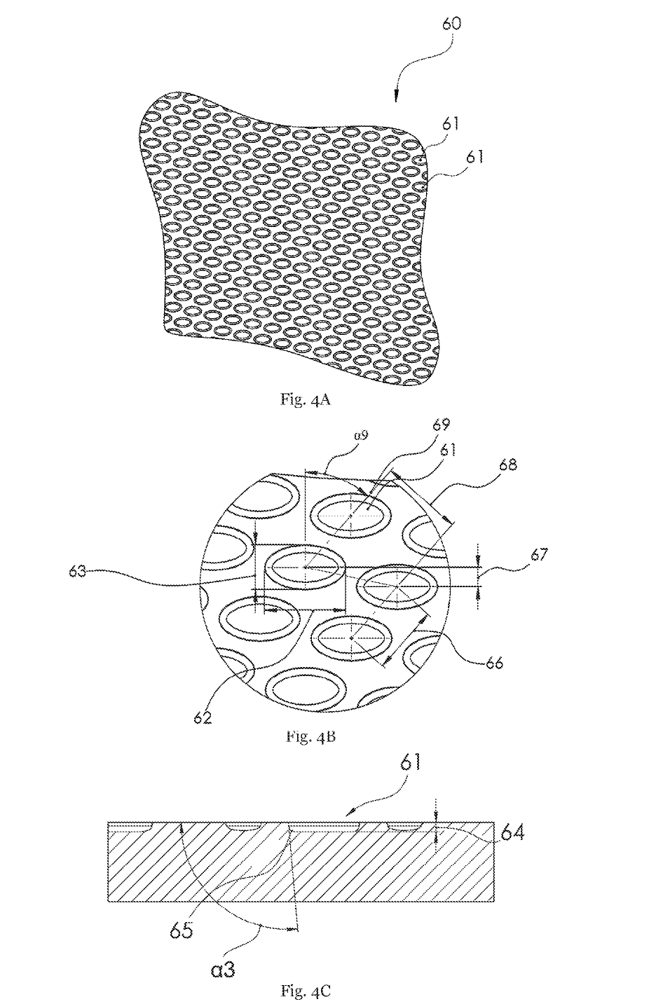

FIGS. 4A-4C show a nanostructure 60 which can for instance be arranged on the inner surface of duct 2 and/or on stator blades 10 and/or on rear stator blades 20. Nanostructure 60 has a pattern of recesses 61 for receiving substantially stationary air. The dimensions of recesses 61 lie in the order of magnitude of several μm to several mm. In this example the dimensions are substantially oval, but can take any desired form. In this example the length 62 of each recess is about 4.2 mm. The width 63 of each recess in this example is about 2.3 mm. In this example the depth 64 of each recess is about 0.7 mm. The peripheral wall of each recess 61 extends in this example at an angle α3 to the inner surface of the duct and/or the surface of stator blade 10 and/or rear stator blade 20, wherein the angle α8 is in this example about 95°. The peripheral wall of each recess 61 is connected in this example at a rounded angle 65 to the bottom of each recess, wherein the rounded angle 65 in this example has a radius of about 0.6 mm. In this example the recesses 61 are disposed adjacently of each other in a number of substantially straight lines 69, wherein the straight line extends at an angle α4 relative to the central axis 3, wherein the angle α4 in this example is about 41°. In this example a centre-to-centre distance 66 between two recesses 61 disposed in one line adjacency of each other is about 3.8 mm. In this example recesses 61 of two mutually adjacent lines 69 of recesses 61 are disposed offset relative to each other, wherein the offsetting 67 in a direction perpendicularly of the longitudinal direction of duct 2 is in this example about 1.1 mm. A centre-to-centre distance 68 between two adjacent recesses 61 of adjacent lines 69 is in this example about 5.2 mm.

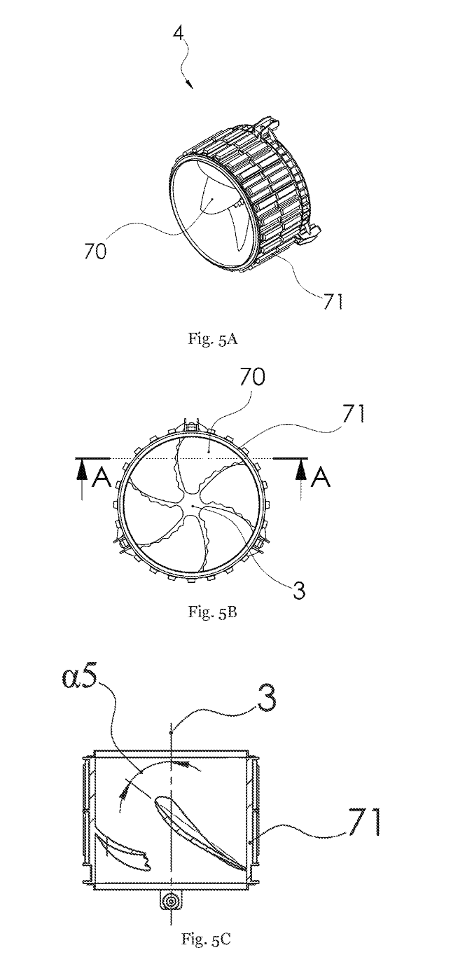

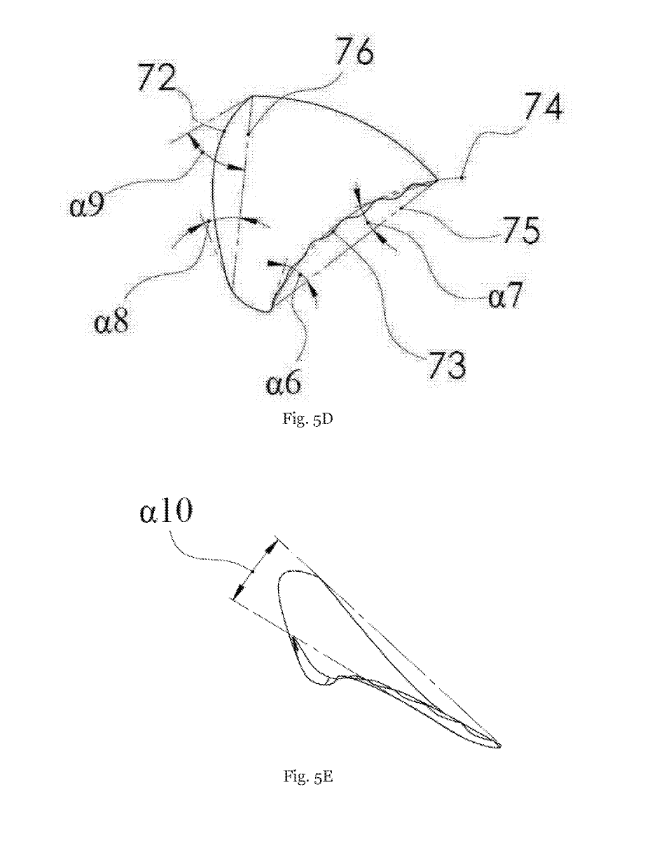

FIGS. 5A-5E show a rotor according to an aspect of the invention. The rotor comprises a number of rotor blades 70, in this example six, which are connected with a peripheral edge to a rotor body 71 of a generator, see also FIG. 1D. Rotor 4 is driven rotatingly by a wind flow flowing in duct 2, whereby rotor body 71 co-rotates. A stator body 77 of the generator disposed in duct 2 is arranged round rotor body 71, see FIG. 1D. As shown in FIG. 5C, rotor blades 70 are disposed at an angle α5 to rotation axis 3, this angle α5 being about 53° in this example. As shown in, among others, FIGS. 5A, 5B and 5D, the rotor blades have a wind entry side with a front end edge 72 and a wind exit side with an end edge 73. End edge 73 is substantially sine-shaped over a curved main line 74. An angle α6 of main line 74 close to an inner end of end edge 73, which is disposed close to the rotation axis coinciding with central axis 3, relative to a straight line 75 between the inner end and the outer end of end edge 73, which is disposed close to rotor body 71, is in this example about 38°. An angle α7 of the main line 74 close to the outer end of end edge 73 relative to the straight line 75 between the inner end and the outer end is in this example about 17°. The front end edge 72 is substantially arcuate. An angle α8 of front end edge 72 close to an inner end of front end edge 72, which is disposed close to the rotation axis coinciding with central axis 3, relative to a straight line 76 between the inner end and the outer end of front end edge 72, which is disposed close to rotor body 71, is in this example about 28°. An angle α14 of front end edge 72 close to the outer end of front end edge 72 relative to the straight line 76 between the inner end and the outer end is in this example about 48°. As can be seen in, among others, FIGS. 5C and 5E, rotor blades 70 are twisted in a direction between an inner end zone and the peripheral edge connected to generator body 71, in this example through an angle α15 of about 5°.

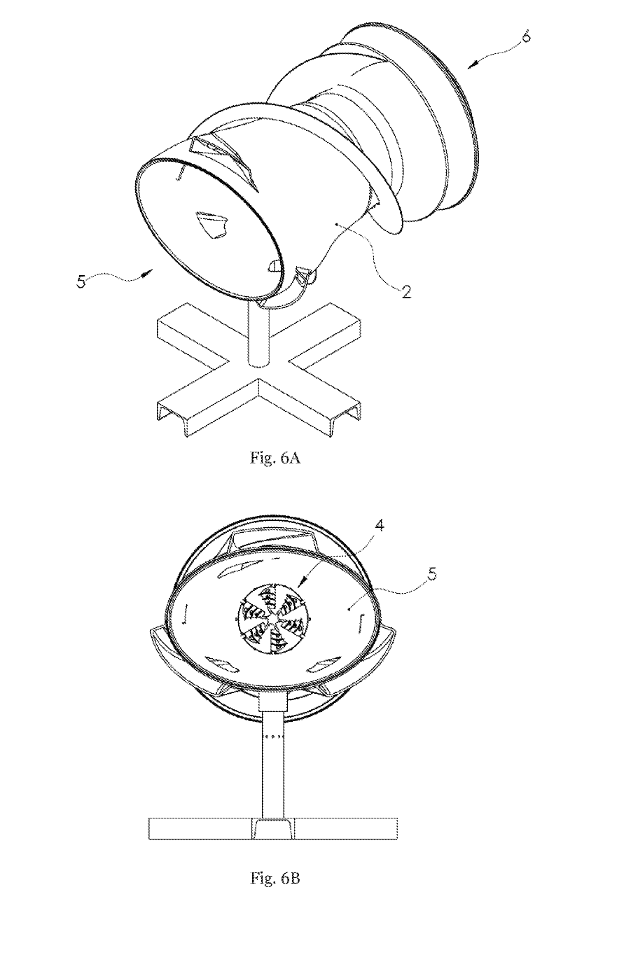

FIGS. 6A and 6B show a wind turbine 1 according to a second embodiment of the invention. Only the differences from the wind turbine of FIGS. 1-5 will be elucidated here, and for a further specification of FIGS. 6A and 6B reference is made to the figure description associated with FIGS. 1-5.

Wind turbine 1 according to the second embodiment of the invention differs from the wind turbine according to the first embodiment in that inlet opening 5 and outlet opening 6 are substantially oval-shaped instead of circular. Duct 2 transposes gradually from its oval end zones or openings 5, 6 to a round cross-sectional form so that the part of duct 2 where rotor 4 is disposed is substantially cylindrical, just as in the wind turbine according to the first embodiment.

It is noted that the invention is not limited to the shown embodiments but also extends to variants within the scope of the appended claims.

The stated values for dimensions, angles and the like are thus given only by way of example. Applicant has found that said values are particularly suitable, but the invention is thus not limited thereto.

It will also be apparent that the form of the inlet opening and/or outlet opening is not limited to the shown circular shape or oval shape, but that it can have any suitable shape. The part where the rotor is disposed is however preferably of circular cross-section, and thereby cylindrical, wherein in the case of a non-circular inlet opening or non-circular outlet opening a gradual transition to this cylindrical part will take place.

1. Device for converting wind energy to at least mechanical energy, comprising:
a rotor with a number of rotor blades drivable rotatably about a rotation axis by wind,
a duct disposed therearound, wherein a central axis of the duct substantially coincides with the rotation axis of the rotor, and
guide means disposed upstream of the rotor for guiding the wind in a substantially helical movement round the central axis during use of the device such that the wind is supplied in the substantially helical movement round the central axis to the rotor.

2. Device as claimed in claim 1, wherein the guide means comprise a number of stator blades disposed in the duct, which stator blades extend radially outward from the central axis.

3. Device as claimed in claim 2, wherein the stator blades have a main plane extending radially from the central axis, which main plane is disposed at an oblique angle relative to the central axis.

4. Device as claimed in claim 3, wherein the stator blades are adjustable for the purpose of adjusting the oblique angle.

5. Device as claimed in claim 4, wherein each stator blade is connected to the duct via a connecting shaft extending radially relative to the central axis such that the stator blade is pivotable about or with the connecting shaft for the purpose of adjusting the oblique angle of the stator blade relative to the central axis.

6. Device as claimed in claim 3, wherein the oblique angle lies between or is adjustable between 10-80°, preferably between 20-60°.

7. Device as claimed in claim 2, wherein each stator blade has at least one through-opening arranged therein.

8. Device as claimed in claim 7, wherein the surface area of the at least one opening is a minimum of 5% and a maximum of 60% of the surface area of a main plain of the stator blade or the main plane of the stator blade.

9. Device as claimed in claim 2, wherein each stator blade is provided with a number of upright ribs extending from a pressure side thereof, which ribs extend from a wind entry side of the blade to a wind exit side of the stator blade, wherein as seen in radial direction the ribs extend obliquely over said side such that on the wind exit side each rib is located at a greater radial distance from the central axis than on the wind entry side.

10. Device as claimed in claim 9, wherein the ribs have a height lying between 0.1% and 25% of the maximum height of the stator blade.

11. Device as claimed in claim 2, wherein each stator blade comprises a wind entry side and a wind exit side, wherein the stator blade is provided on its wind exit side with an end edge, the second derivative of which changes sign more than once.

12. Device as claimed in claim 11, wherein the end edge is sine-shaped, block tooth-shaped or sawtooth-shaped.

13. Device as claimed in claim 11, wherein the end edge is provided with a number of elements which extend in a main plane of the stator blade and which each take the form of a parabola or a part of a circle.

14. Device as claimed in claim 11, wherein the end edge is provided with a number of elements which extend in a main plane of the stator blade and which each take a substantially feather-like form.

15. Device as claimed in claim 2, wherein each rotor blade comprises a wind entry side and a wind exit side and is provided on its wind entry side with a front end edge, which front end edge comprises an inner end, which is disposed close to the rotation axis, and an outer end and wherein a main line of the front end edge between the inner end and the outer end takes a substantially curved form.

16. Device as claimed in claim 15, wherein an angle of the main line close to the inner end of the front end edge relative to a straight line between the inner end and the outer end is greater than −45° and smaller than 45°, preferably greater than −25° and smaller than 25°.

17. Device as claimed in claim 15, wherein an angle of the main line close to the outer end of the front end edge relative to a or the straight line between the inner end and the outer end is greater than −60° and smaller than 60°.

18. Device as claimed in claim 1, wherein the rotor blades are disposed at an angle to the rotation axis, wherein the angle is greater than 35° and smaller than 75°, preferably greater than 40° and smaller than 65°.

19. Device as claimed in claim 1, wherein at least the inner side of the duct from the inlet opening to at least a position close to the rotor has the form of a Venturi narrowing in flow direction.

20. Device as claimed in claim 1, wherein the duct is provided on its outer side with at least one wind capture element extending radially outward, which at least one wind capture element is provided with at least one channel extending to the inner side of the duct.

21. Device as claimed in claim 20, wherein the at least one channel extends along at least a part of its length in flow direction through the duct in substantially helical form round the central axis for the purpose of supplying the wind in said substantially helical movement to the inner side of the duct.

22. Device as claimed in claim 21, wherein said part of the channel debouches with an outlet opening on the inner surface of the duct.

23. Device as claimed in claim 20, wherein a dimension of the cross-sectional surface area of the at least one channel decreases along at least a part of its length in downstream direction.

24. Device as claimed in claim 2, wherein the stator blades are provided with a structure, which structure has a pattern of recesses for receiving substantially stationary air.

25. Device as claimed in claim 24, wherein the structure is has at least one of the following features
a depth of each recess is between 0.1×-2× the length of each recess;
a width of each recess is between 0.8×-3.5× the length of each recess;
the recesses have an oval shape, a longitudinal axis of which is disposed at an angle relative to the central axis, wherein the angle lies preferably between 0° and 45°;
the peripheral wall of each recess extends at an angle to the inner surface of the duct, wherein the angle lies preferably between 90 and 100°;
the peripheral wall of each recess is connected at a rounded angle to the bottom of each recess, wherein the rounded angle has preferably a radius of between 0×-1× the length of each recess;
the recesses are disposed adjacently of each other in a number of straight lines, wherein the straight line extends at an angle relative to the central axis, wherein the angle lies preferably between 0° and 90°, wherein a centre-to-centre distance between two recesses disposed adjacently of each other in one line lies between 1×-4× the width of each recess, and wherein the recesses of two mutually adjacently disposed lines of recesses are arranged offset relative to each other, wherein the offsetting is greater than 0× the length of each recess and a maximum of 2× the length of each recess.
